(19) United States
(12) Patent Application Publication
(10) Pub. No.: US 2010/0304783 A1
(43) Pub. Date: Dec. 2, 2010

(54) SPEECH-DRIVEN SYSTEM WITH HEADSET

(76) Inventors: James R. Logan, Pittsburgh, PA (US); Ryan Zoschg, Pittsburgh, PA (US); Sean Nickel, Monroeville, PA (US)

Correspondence Address: WOOD, HERRON & EVANS, LLP, 2700 CAREW TOWER, 441 VINE STREET, CINCINNATI, OH, 45202, US

(21) Appl. No.: 12/474,398

(22) Filed: May 29, 2009

(51) Int. Cl. H04M 1/00; G10L 15/26

(52) U.S. Cl. 455/552.1; 704/235; 455/569.1; 704/E15.043

(57) ABSTRACT

A speech-directed system for doing tasks utilizing human speech includes a headset including a microphone for capturing user speech from a user and a speaker for playing audio to a user. A speech recognition component is resident on the headset and operable for converting the user speech to data in a data format. A WPAN radio component is resident on the headset and is configured for converting the user speech data from the data format into a protocol format. A host device is configured with a WPAN radio component for transceiving user speech data with the headset in the protocol format. A long range wireless network component that is resident on the host device couples with at least one remote device through a long range wireless network. The host device is operable for transceiving the user speech data with the remote device.

This invention is directed to a system that is interfaced with using human speech and particularly with a system utilizing a headset for human speech interaction.

### BACKGROUND OF THE INVENTION

Human voice, and more particularly human speech, is utilized as a means to accomplish a variety of tasks beyond just traditional human-to-human communications. In one particular speech-driven environment, a plurality of tasks, such as work-related tasks or other tasks, are facilitated through a speech interaction. For example, in a speech-driven work environment, bi-directional speech is utilized as a tool for directing a worker to perform a series of tasks and for obtaining input and data from the worker. Such speech-driven systems often utilize a central computer system or network of systems that controls a multitude of work applications and tracks the progress of the work applications as completed by a human worker. The central system communicates, by way of a speech dialog, with multiple workers who wear or carry mobile or portable devices and respective headsets.

More specifically, through the mobile devices and headsets, the workers engage in a bi-directional speech dialog and, as part of the dialog, the workers receive spoken directions originated by the central computer system and provide responses and data and other spoken input to the central computer system using human speech. Specifically, the mobile devices take advantage of text-to-speech (TTS) capabilities to turn data to speech and to direct a worker, with the synthesized speech, to perform one or more specific tasks. Such devices also utilize speech recognition capabilities to convert the spoken utterances and speech input from the worker into a suitable digital data form that may be utilized by the central computer system and the applications that it runs. The mobile devices are coupled to a headset that includes a microphone for capturing the speech of a user and one or more speakers for playing the synthesized speech to a user. The headset user is able to receive spoken instructions about a task, to ask questions, to report the progress of the task, and to report various working conditions, for example.

As may be appreciated, such speech-driven systems provided significant efficiency in the work environment and generally provide a way for a person to operate in a hands-free and eyes-free manner in performing their job. The bi-directional speech communication stream of information is usually exchanged over a wireless network between the mobile terminal devices and the central system to allow operator mobility.

Generally, for implementing speech-driven systems, a headset is worn by a user and is connected to the mobile device that is worn or carried by a user. The headset might be connected to the terminal device in a wired or wireless fashion. Conventionally, the headset simply captures audio signals, such as speech, from a user and sends those audio signals to the terminal device. The headset also plays audio signals that are sent to it from the terminal device using one or more speakers. The signal processing for such audio signals, such as the text-to-speech (TTS) applications or speech recognition applications are usually implemented on the mobile device. To interface with the central system, the mobile device also utilizes transceiver or radio components to provide such an interface in a wireless fashion.

For example, one prevalent speech-driven system is the Talkman® system provided by Vocollect, Inc. of Pittsburgh, Pa. The Talkman® system utilizes a mobile, body-worn device that has a wireless LAN (WLAN) connection to a central system or other networked system. The mobile device takes user speech that is captured by the headset, converts it to a suitable data format, and then wirelessly transmits the user speech data back to a central system. Conversely, text and data from a central system are sent wirelessly to the terminal, and are utilized, via the headset, and speech synthesized by the mobile device for the bi-directional speech dialog with a user.

Some attempts have been made to provide a headset which incorporates the functionality of both a traditional headset, as well as the mobile processing device. That is, the headset provides both the audio functionality of a headset as well as the speech recognition and text-to-speech capabilities along with a radio or transceiver functionality to wirelessly communicate with a remote system. However, as may be appreciated, the processing bandwidth that is necessary to support speech recognition can be significant, and thus, add weight and complexity to a wireless headset. Furthermore, the radio or transceiver functionality for a wireless network link, such as a wireless LAN connection, requires significant power. As such, a heavy battery is required in such a headset. Since headsets are often worn for significant amounts of time in a speech-driven environment, comfort is always a paramount issue for designing and implementing a headset. The heavy batteries and power sources, as well as the electronics for a wireless headset, that are required to provide the desired functionality in a headset for a speech-driven environment, provide significant obstacles.

Accordingly, there is a need in the art for speech-driven systems that have a suitable headset that has the desired speech processing functionality without undesirable weight characteristics that are uncomfortable to the wearer. Furthermore, there is a need within speech recognition systems for devices that provide speech functionality in a headset without significant power requirements that mandate that a heavy battery be worn on the head. Still further it is desirable within a speech-driven system to provide speech recognition functionality that is flexible and may be implemented utilizing a variety of different remote devices, and not just a dedicated mobile device that is specifically designed for the headset. These needs, and other needs within the art, are addressed by the present invention, which is described in greater detail hereinbelow.

### BRIEF DESCRIPTION OF THE DRAWINGS

FIG. 1 is an illustrative view of a user utilizing an embodiment of the invention.

FIG. 2 is another illustrative view showing the relationship of a user to a remote network device 32 in accordance with the invention.

FIG. 3 is a schematic block diagram of a headset used in an embodiment of the invention.

FIG. 4 is a schematic block diagram of application layers and other layers associated with an embodiment of the invention.

FIG. 5 is a schematic block diagram showing an embodiment of the invention.

### DETAILED DESCRIPTION OF THE INVENTION

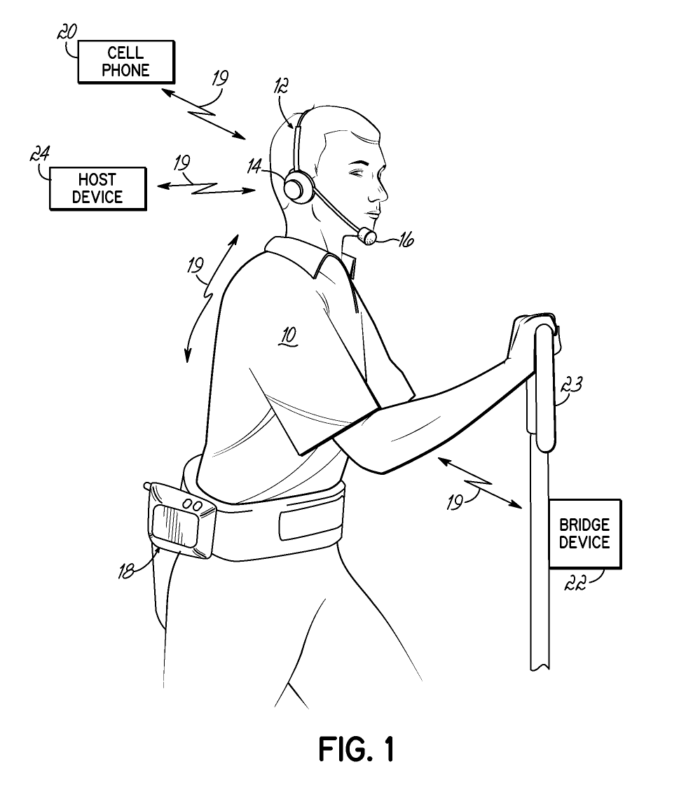

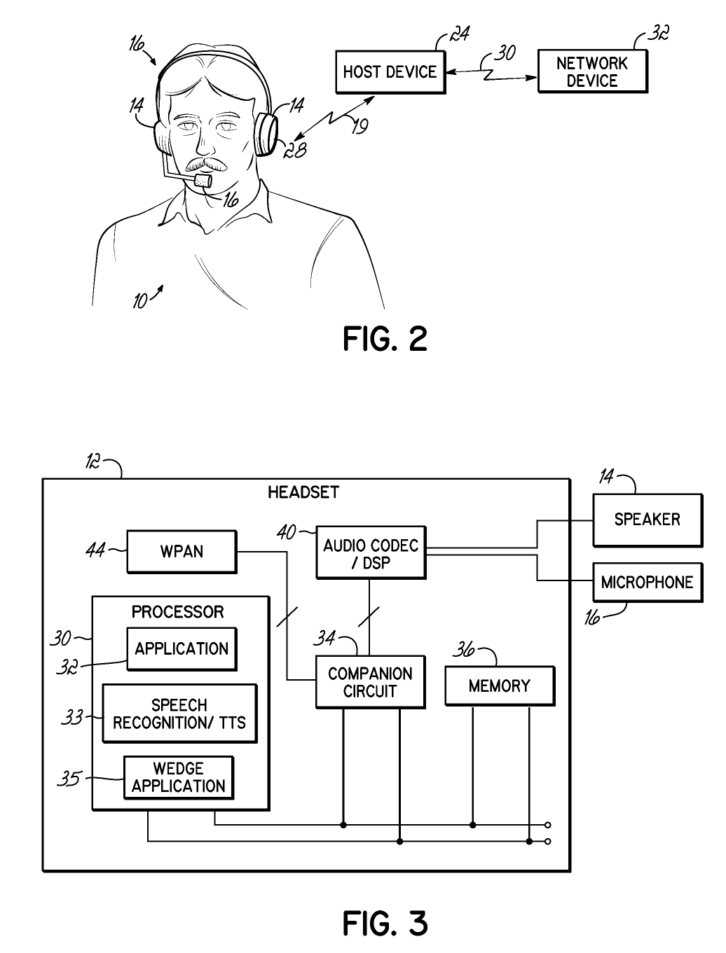

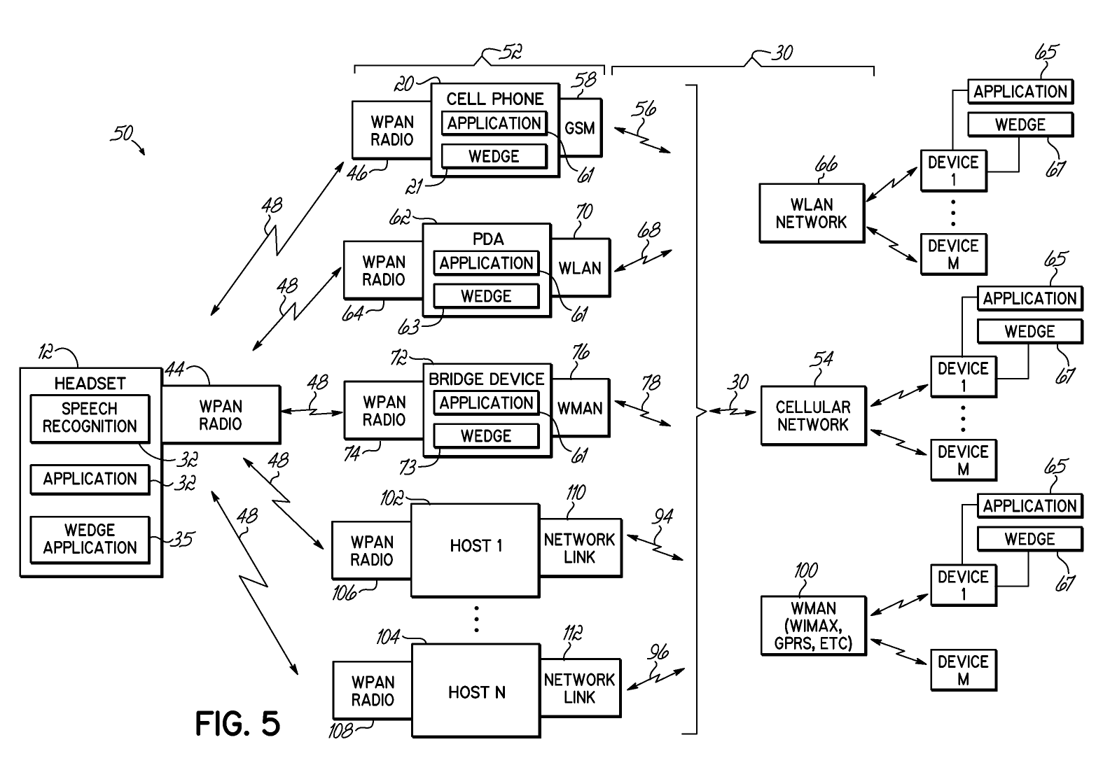

FIG. 1 illustrates a user implementing a speech-driven system in accordance with the present invention. Particularly, the user 10 wears a headset 12 for communicating in accordance with the principles of the invention. The headset 12 includes one or more speakers 14, and one or more microphones 16 for providing audio signals, such as in the form of synthesized or real speech, to the user 10, and also capturing spoken utterances and speech from the user. In accordance with the principles of the present invention, the headset 12 also includes suitable hardware and processing capabilities for implementing speech recognition and text-to-speech (TTS) functionalities for both capturing user speech and converting it into other usable data formats, as well as synthesizing speech from text and data in various electronic formats. Headset 12 has a wireless functionality for communicating with various host devices 18, 20, 22, and 24, through a wireless personal area network (WPAN) link, such as the medium to provide the use of human speech to interface with a number of different remote devices (See FIGS. 2 and 5) that are networked with one or more of the host devices

For example, as illustrated in FIG. 1, and discussed further hereinbelow, the headset 12 might utilize a suitable WPAN wireless connection 19 to interface with a mobile or portable device 18 that is worn or carried by the user 10. Similarly, a suitable WPAN wireless connection between headset 12 and a cell phone 20 carried by user 10 might also be achieved utilizing the invention. Also, various different bridge devices 22 that are proximate to the user's workspace or mounted on equipment such as pallet jack 24 might be accessed through a suitable WPAN wireless link 23 in accordance with the principles of the invention. Generally, for illustrating the invention, such devices 18, 20, and 22 are referred to as host devices 24, and such host devices interface directly with headset 12 according to the principles of the invention.

Referring to FIG. 2, headset 12 of the present invention incorporates processing circuitry 28 for implementing a speech recognition functionality and a WPAN wireless link 19 to one or more host devices 24, such as a wearable mobile device 18, as illustrated. The host device 24, in turn, provides a longer range wireless link through a wireless network indicated by 30 to one or more remote networked devices 32 to thus, provide speech-driven interaction or control of the remote devices 32 utilizing headset 12. As discussed further hereinbelow, the host device 24 might be any number of different devices that implement a suitable communication protocol within a suitable WPAN standard. Furthermore, as discussed hereinbelow, the wireless network 30 used to couple the host 24 with remote network devices 32 might include various suitable networks, such as a WLAN network, a cellular network, or a WMAN network, (e.g., a WiMAX network).

The speech-driven system of the present invention provides a speech functionality to various remote devices 32 that generally do not have the processing bandwidth or processing capability (hardware/software) to support speech recognition and TTS functionalities in a stand-alone manner. Furthermore, another benefit of the present invention is the increased flexibility of interfacing with various different remote and networked devices and systems 32 utilizing speech, wherein the speech functionality is maintained locally at the user through a wireless headset. Through the implementation of a WPAN link to a variety of different host devices, the specific network functionality (e.g., WLAN, cellular, WMAN, etc.) may be utilized without maintaining such long range communication hardware and software on the headset. The present invention thus, provides for a speech-driven system with a headset that is lightweight, is less complicated, and does not require the high power consumption, or a heavy battery associated with such long range communication technologies. Furthermore, the present invention removes the need to have a high-power RF transceiver proximate the head of the user.

FIG. 3 illustrates one exemplary embodiment of a headset 12 of the present invention that provides desirable speech functionality for use in a speech-driven system. The headset also includes the desired operability for wirelessly coupling with one or more different host devices 24, in order to utilize the network capabilities of those host devices for providing speech-functionality to the different remote devices and systems that are networked through the host. Referring to FIG. 3, headset 12 includes a processor 30, which operates according to a suitable operating system. Processor 30 runs one or more application programs or applications 32, including speech recognition and TTS programs 33 or wedge applications 35, to provide the desired speech functionality of the headset 12. Processor 30 might be coupled with a suitable companion processor circuit 34, and also suitable memory 36. The processor, companion processor circuit, and memory are all appropriately inter-connected through suitable connections and address and data buses as would be understood by a person of ordinary skill in the art.

Headset 12 also includes one or more speakers 14, and one or more microphones 16 for providing the audio interface with user 10 that the speech-directed system of the invention requires. Microphone 16 captures audio signals from the user, such as the speech utterances of the user. When the user 10 speaks into microphone 16, the captured audio signals from the microphone are forwarded to a suitable coder/decoder circuit (CODEC) or DSP 40 or other suitable digital signal processing circuit. The audio signals or audio data are digitized by CODEC 40 and then utilized for further processing in accordance with the principles of the present invention. In the output direction, the CODEC/DSP circuit is also coupled to speaker 14 to provide audio output to the user. In accordance with a speech-driven system, such an audio output may be in the form of a computer-synthesized speech that is synthesized from text or other data in accordance with the TTS functionality 33 of the headset. However, as the present invention may also be used to provide the speech-driven interface to a cellular phone, the signals provided to speaker 14 through the CODEC/DSP 40 may be pure audio signals, such as from a cellular telephone call.

The WPAN radio hardware and software platform 44 incorporates suitable hardware/software layers depending on the technology implemented in the platform. If an ultra-wideband (UWB) platform was used in the WPAN radio link, media access control (MAC) layer specifications and physical (PHY) layer specifications based on Multi-Band Orthogonal Frequency Division Multiplexing (MB-OFDM) could be implemented for example. Such a platform provides a desirable low power consumption in a short range wireless link to various host devices for multi-media file and data transfers. While various UWB radio platforms might be utilized for the WPAN, one embodiment of the present invention utilizes the WiMedia/UWB platform that provides data transfer rates of 480 Mb/s and operates in the 3.1-10.6 Ghz UWB spectrum. The UWB system provides a wireless connection between headset 12 and the host device 24 with data payload capabilities of 53.3, 55, 80, 106.67, 110, 160, 200, 320, and 480 Mb/s.

The WPAN link might also be implemented with various network technologies, such as infrared Data Association (IᵣDA) technologies, Bluetooth, UWB, Z-Wave, ZigBee.

As discussed further hereinbelow, if a WiMedia/UWB platform is used to implement the WPAN link, it may be optimized for complimentary wireless personal area network (WPAN) technologies such as Bluetooth 3.0, wireless USB, IEEE wireless 1394, and wireless TCP/IP, also called Universal Plug-n-Play (UPnP) protocols. As such, the present invention provides connectivity in a speech-driven system to a large variety of different host devices that may operate using one of the protocols suitable with the WiMedia/USB platform.

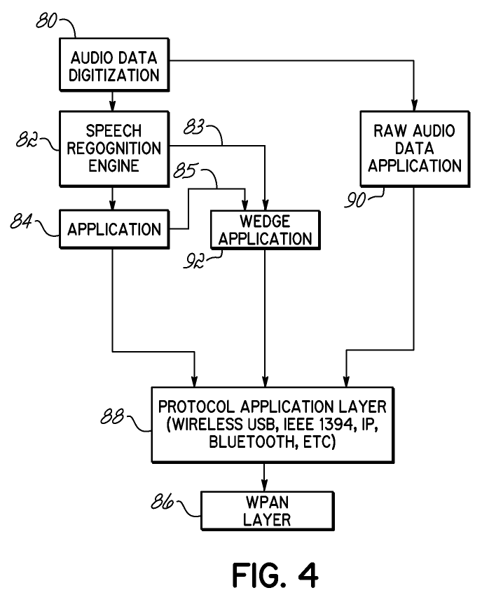

As illustrated in FIG. 5, in accordance with one aspect of the present invention, the speech-driven system 50 incorporates a headset 12, with speech operability provided by the speech recognition application 33. A WPAN radio 44 provides speech operability to a plurality of host devices, as illustrated collectively as 52 in FIG. 5. In accordance with one aspect of the present invention, and discussed further below with respect to FIG. 4, headset 12 is able to capture speech utterances of a user that are processed by the speech recognition engine 32 and other suitable processing applications. The speech utterances are utilized to interface with one or more host devices 52, and in turn, interface with another network implemented by each of those host devices 30 (See FIG. 5). While the headset 12 interfaces with the host devices 52 through the WPAN wireless link 48, each of the host devices 52 may have their own associated networks 30 to provide a network of the headset 12 with other networked devices (Device 1-Device M) as illustrated in FIG. 5.

For example, one possible host device might be a cell phone 20, which includes a WPAN radio 46 for wirelessly coupling with headset 12 through wireless link 48. Generally, the cell phone 20 will be carried by the same person wearing headset 12, and thus, will be in proximity for the range of the WPAN link 48. The cell phone 20 is also coupled with a cellular network 54 through a suitable cellular wireless link 56, such as a GSM link. In the illustration shown in FIG. 5, the cell phone 20 has suitable radio components 58 (e.g., GSM) for cellular network functionality. As will be readily understood by a person of ordinary skill in the art, other cellular links for cellular network 54 might be utilized in addition to a GSM link. In the illustration of FIG. 5, reference numeral 30 indicates any number of different long range wireless links, such as links to WLAN networks, cellular networks, WMAN networks, etc. Furthermore, each of those networks 30 will also connect with a number of different remote devices (Device 1-Device M) through the appropriate network, as illustrated in FIG. 5.

In another example of the present invention, the host device might be a personal data assistant (PDA) 62, which may be carried by a user. A PDA host device includes a suitable WPAN radio component or functionality 64 for coupling with headset 12 through the wireless link 48. PDA 62 might be carried in the pocket of a user, or worn on a belt like device 18, as illustrated in FIG. 1. While the PDA might operate in a stand-alone fashion, it might also couple with a long range wireless network, such as a WLAN network 66, through an appropriate wireless link 68, using radio component 70 for the WLAN link.

In another embodiment of the invention, some other suitable bridge device 72 might be either carried by the user, or implemented proximate to where the user is working in order to couple to both the headset 12 and to another long range network 30 to provide the speech-directed system of the invention. For example, as illustrated in FIG. 5, a bridge device 72 might include a suitable WPAN radio component 74 and a WMAN radio component 76 for providing a suitable long range wireless link 78 to a WMAN network 100. Such a network might include a WiMAX network, a GPRS network, or some other suitable wireless metropolitan area network. Other host devices 102, 104 (Host 1-Host N) include suitable WPAN radio components 106, 108, and suitable network links 110, 112 for providing interconnectivity with a variety of networks indicated collectively by reference numeral 30 in FIG. 5 utilizing suitable wireless links 94, 96.

While the illustrations shown in FIG. 5 and discussed herein each show a host device 52 coupled to a long range wireless network 30, any one of the host devices might operate by itself, without interconnectivity to the long range network 30. For example, a cell phone might be utilized in conjunction with the headset 12 of the invention for providing operation and control of the cell phone in order to make calls. The bi-directional audio stream might then be provided to a user, not using the speakers and microphone of the cellular phone, but rather using the headset 12 coupled to cellular phone 20. Similarly, a PDA 62 may operate in a stand-alone fashion, and may provide desired processing functionality for running various applications and providing a bi-directional speech dialog with headset 12 and a user in accordance with one aspect of the invention. Accordingly, the present invention is not limited to a speech-directed system with host devices that are connected in a long range wireless network 30.

Turning to FIG. 4, various hardware/software functionality, application layers, protocol layers and physical layers, for implementing one embodiment of the invention are illustrated. In the voice-directed system 50, speech and particularly the speech utterances of a user are captured. The user speech is captured by headset 12, as illustrated in FIGS. 1 and 2, and is directed to suitable audio CODEC/DSP circuitry 40 for providing digitization and processing of the audio data associated with the user speech, as shown in block 80. The user speech is captured in its audio form by microphone 16, and must be properly converted for further processing and transmission in accordance with the principles of the invention. As illustrated in FIG. 4, the audio data digitization step 80 begins the flow of the speech in the speech-directed system of the invention. In one embodiment of the invention, the digitized audio data is directed to the speech recognition, application, or engine, or recognizer, as illustrated by block 82. The speech recognition engine, which is implemented by a suitable software application 33 and processing circuitry such as a processor 30 or some other suitable digital signal processing circuitry, converts digitized audio data into recognized speech text.

In one particular feature for the invention, the speech text can be utilized within applications directed to speech-directed work. Utilizing the speech text, as well as the TTS capabilities of the speech recognition engine, a speech dialog may be facilitated by one or more applications, as illustrated in block 84. The applications may direct a user how to perform particular work tasks utilizing speech, and may receive, from user speech, input about the task, data, or other information regarding the progress of the work task, in order to facilitate the work as well as document that work and its progress. For example, the owner of the present application, Vocollect, Inc. of Pittsburgh, Pa., provides a Talkman® application and system for voice-directed work associated with warehouse management/inventory management/order-filling. However, other applications might be utilized to provide a bi-directional speech dialog in accordance with the speech-directed system of the invention.

The application or applications indicated by block 84 may be customized by various users based upon their particular use and a particular function of headset 12. As part of the application layer 84 of the system, data is consumed or received, as well as generated by the applications of that layer. In one embodiment of the invention, that data will be sent to a host device, and possibly to a remote system or network for further processing and data capture. Similarly, in providing data to be used by the one or more applications 84, the host devices or remote devices may actually provide data to the headset 12 to be processed by the applications run by the processing circuitry of the headset.

Using voice, data is provided to the host device 24, wherein the host device processes the data and/or provides a network link to the remote devices or system that implements or processes the data generated by the headset 12. In accordance with one aspect of the present invention, a WPAN link is provided, and thus, in the processing flow of data as illustrated in FIG. 4, a WPAN physical layer 86 is implemented within the respective WPAN circuitry 44 of headset 12. The WPAN layer generally includes both a particular radio platform and media access control (MAC) data communication protocol sublayer as well the physical layer or PHY layer that interfaces between the MAC layer and a physical medium such as cable or wire components or wireless components for providing the WPAN wireless links 48. Such a WPAN layer 86 is effectively implemented in the WPAN radio components 44 of the headset and in the respective WPAN radio components of the various host devices, as illustrated in FIG. 5.

The WPAN wireless link 48 provides a necessary link between the headset 12 and host of the invention for implementing the speech-directed system of the invention utilizing the speech recognition engine 12 on the headset. The WPAN link 48 also provides a network link functionality for the headset to the various host devices that are connected to various different wireless networks and devices that are remote from the user and the headset 12. To interface with the WPAN layer 86, one or more different operating system protocols are utilized and provided by the operating system implemented in the processor circuitry 30, 34 of headset 12, and those protocols are referred to as protocol adaptation layers (PAL) 88.

The WPAN link of the invention may be implemented through a number of suitable wireless technologies and protocols as noted. For a UWB embodiment, the protocol application layer 88 as implemented by the processing system of headset 12 would provide the necessary services and drivers for various different technologies including, for example, Bluetooth 3.0, certified wireless USB, the IEEE 1394 interface (Firewire) protocol adaptation layer, and the wireless TCP/IP protocol, often referred to universal plug-n-play (UPnP). Such various different wireless protocols can operate within the same wireless personal area network without interference. In addition to such noted protocol application layers, other industry protocols or physical mediums can be implemented utilizing the WiMedia/UWB functionality of the invention, including Ethernet, DVI, and HDMI physical mediums, for example. Various implementations of such protocols on top of the WPAN platform may be implemented in a suitable fashion, as understood by a person of ordinary skill in the art.

As in one such embodiment of the invention as discussed above, the recognized speech data is handled by application layer 84, and that data is sent to a host device and/or on to a remote system. Alternatively, data is received from the host device or remote system, and may be played as a spoken synthesized voice to a user. The protocol application layer 88 and WPAN layer 86 provide the link to a suitable host. The user speech data is processed at the host device or might be forwarded to a remote system utilizing the wireless network operated by the host device. For example, the PDA component 62 might process the user speech data and otherwise interact with the user. Also, the PDA host device 62 has a WLAN functionality with a wireless link 68 for connectivity to a WLAN network 66. This provides headset and host device connectivity to one or more remote devices (device 1 . . . device M) coupled to the WLAN network 66. One of the remote devices 1-M might be a server or computer, for example, which runs an application such as a warehouse management application. That warehouse management application directs a number of users wearing respective headsets 12 to perform various tasks associated with order filling and inventory management within a warehouse. The data associated with tasks to be performed by a particular user are provided to the host 62 through network 66 and wireless link 68. That data is further forwarded to headset 12 through the WPAN radio capability of host 62. Since headset 12 handles the speech recognition functionality, the host 62 does not have to provide the bi-directional speech dialog functionality of the system. Rather, the host can be a somewhat “dumb” host with respect to the speech features of the invention because the headset 12 handles the speech processing. However, the remote link capabilities of the host devices 52 may be utilized, thus, eliminating the need to accommodate the high power consumption of that remote link on the headset 12. In that way, weight from a large battery is eliminated on headset 12 because the power consumption at the headset is decreased by around fifty percent. Thus, the size of the battery and the overall size of the headset may be decreased accordingly. As noted above, the various host devices can be any suitable device that supports a WPAN interface. For example, a cell phone 20 might be utilized as well as a PDA 62. Other hosts might include MP3 players, ruggedized hand-held devices, or any stationery or mobile computers. Furthermore, various such devices might be developed to act as bridge devices, and could be mounted on equipment or structures proximate to the user. For example, a bridge device 72 may be mounted on a shelf that supports product, or could be mounted on a pallet jack or a delivery truck that is utilized to move the product. Similarly, various such bridge devices might be designed to be body-worn or otherwise carried by a user who is wearing a headset 12.

Accordingly, in one aspect of the present invention, a variety of different speech-directed work may be performed through communication between headset 12 and an appropriate host device, which couples through a wireless network to more remote systems and applications.

In accordance with another aspect of the present invention, rather than directing the audio data to a speech recognition engine as noted in block 82, the raw audio data may be directed to an application that converts the data to streaming audio, a voice over IP (VoIP) format, or some other suitable format for providing a communication link with the user of a headset to talk directly to another person. The raw audio data from the application of block 90 may then be directed to a suitable host device in accordance with the principles of the present invention through a WPAN wireless link, as implemented by the protocol application layer 88 and the WPAN layer 86.

For example, in the raw data format, the host device might be a cellular phone, and the user would be able to carry on a suitable telephone conversation on the cellular phone, such as utilizing a Bluetooth connection with the host device through the WPAN platform. Alternatively, the host device might be a portable computer, such as a PDA, which incorporates a WLAN link 68 to provide a voice-over IP (VoIP) connection with another remote device that is connected to the WLAN network 66, as illustrated in FIG. 5.

In accordance with another aspect of the invention as illustrated in FIG. 4, the output of the speech recognition block 82 might be output to a wedge application, as illustrated by block 92. The wedge application provides the output of the recognition engine in the form of a text or recognized data as input data to an application on another device. The speech recognition results, as indicated by path 83, may be provided directly from the speech recognition application, as indicated by path 83. The wedge application 92 then converts the recognized data or text into a format that may be used directly by a host device, or which may be passed by the host device through one of the appropriate wireless networks 30 to one or more remote devices (Device 1-Device N). The wedge application 92 may provide suitable formatting of the data from the speech recognition engine 82 so that data may be utilized in a number of different ways. For example, the host device might run one or more applications 61 that may utilize data provided from the speech recognition process. Alternatively, the speech recognition data might be passed through the host device to be used in an application 65 that exists on a remote device (Device 1-Device N) or some other device that is linked to the host via a suitable wireless network 30.

To that end, the wedge application 35 of layer 92 in FIG. 4 might be implemented on the headset 12 in order to properly format the data to be sent to the host via the WPAN link 48. In an alternative embodiment of the invention, as illustrated in FIG. 5, the wedge functionality of layer 92 might be implemented on a host device or on a more remote device. For example, as illustrated in FIG. 5, a host device, such as a cellular phone 20 or PDA 62, might include a wedge application 21, 63, respectively. In another example, the suitable bridge device 72 utilized to provide a bridge between headset 12 and one or more remote devices (Device 1-Device M) might contain the wedge application 73. Similarly, the other host devices might also incorporate such a wedge application. In another embodiment, a wedge functionality 67 might be used on a remote device (1-M) to interface with an application 65 on the device (1-M) or an application on some other device. In that way, voice and speech may be utilized to provide control of one or more of the host devices or one or more of the remote devices. Furthermore, data might be provided, by way of user speech, to the host devices or the remote devices that are coupled with the host devices. In that way, voice may be used as a means for control and data entry for host and more remote devices to supplement and/or replace traditional data entry and control devices.

For example, in one embodiment of the invention, user speech might be provided through headset 12 to interface with a host device, such as a computer. The host computer may have information stored thereon in a database that might normally be accessed using a mouse or keyboard or might have some other application 61 that would require the data from a voice input. The user might speak a certain command, telling the host computer to access the database or run the application in a certain way. The speech of the user is recognized utilizing a speech recognition engine to provide certain command words. The wedge application 92 then converts those command words into the proper format that is recognized by the host device/computer or application as the necessary keystrokes or mouse input to access the database or run the application. Information might then be retrieved from the database in the form of text, which is then converted into a suitable format utilizing a wedge application 92, and forwarded to the TTS application 82 of the headset, wherein it is played as suitable audio to the user. In that way, information might be obtained through the host device, utilizing speech via the headset 12 and its WPAN link with the host device. Similarly, one or more remote devices (Device 1-Device M) might be controlled in the speech-directed system of the invention utilizing headset 12 and the access provided to the remote devices through the host devices. For example, one of the remote devices might be the computer having the database which must be accessed. A wedge application functionality 92 provided on either the headset 12 or the host device 52 or the remote device (1-M) may convert the spoken input from a user and from the speech recognition engine 82 into the necessary format for controlling the remote device or running an application 65 on the remote device and accessing information on that remote device, such as a remote computer or server.

In an alternative embodiment of the invention, as illustrated by path 85 in FIG. 4, an application layer run on headset 12 may utilize the output data from the speech recognition engine 82 directly in order to further manipulate that data before it passes through the wedge application 92, and to the host device or remote device via the WPAN link provided by the invention.

As discussed above, headset 12 of the invention utilizing the speech recognition functionality 82 and the WPAN wireless link 48 may be utilized to control and access a number of host devices and also a number of remote devices through the long range wireless links provided by the various host devices. Not only may headset 12 and user speech be used to provide data to one or more hosts or one or more remote devices, but the speech might also be used, as formatted by wedge application 92, to control the host devices and remote devices or to receive input from the remote devices and host devices and play it as audio for the user. For example, information from a remote device or host device may be formatted through an appropriate wedge application 6, 67, 92 into suitable text for use by a TTS functionality of the headset 12. In that way, a bi-directional exchange of information may be implemented utilizing the invention.

What is claimed is:

1. A speech-directed system for doing tasks utilizing human speech comprising:
a headset including a microphone for capturing user speech from a user and a speaker for playing audio to a user;
a speech recognition component that is resident on the headset and operable for converting the user speech to data in a data format;
a WPAN radio component that is resident on the headset and configured for converting the user speech data from the data format into a protocol format;
a host device configured with a WPAN radio component for transceiving user speech data with the headset in the protocol format;
a long range wireless network component that is resident on the host device for coupling with at least one remote device through a long range wireless network, the host device operable for transceiving the user speech data with the remote device.

2. The speech-directed system of claim 1 wherein the WPAN radio component uses a UWB protocol format.

3. The speech-directed system of claim 1 wherein the long range wireless network includes at least one of a cellular network, a WLAN network or a WMAN network.

4. The speech-directed system of claim 1 further comprising at least one application resident on the headset and configured for receiving the user speech in the data format, the application using the user speech data for directing a user in the completion of a work task.

5. The speech-directed system of claim 1 further comprising a wedge application, the wedge application converting the user speech data into another data form usable by the host device or the at least one remote device for interfacing with the remote device using speech.

6. The speech-directed system of claim 5 wherein the wedge application is resident on the headset.

7. The speech-directed system of claim 5 wherein the wedge application is resident on the host device.

8. The speech-directed system of claim 5 further comprising a remote device, the wedge application being resident on the remote device.

9. The speech-directed system of claim 1 wherein the host device is a bridge device configured with an application to convert the data from a WiMedia/UWB radio protocol format into a format for use in a long range wireless network for transceiving the user speech data with the remote device.

10. The speech-directed system of claim 1 further comprising at least one application resident on the host device and configured for receiving and using the user speech data.

11. The speech-directed system of claim 1 further comprising a remote device, at least one application resident on the remote device and configured for receiving and using the user speech data.

12. The speech-directed system of claim 1 wherein the UWB protocol format implements at least one protocol from the group of a wireless USB protocol, an IEEE 1394 protocol, a Bluetooth protocol, and a wireless TCP/IP protocol.

13. A speech-directed system for doing tasks utilizing human speech comprising:
a headset including a microphone for capturing user speech from a user and a speaker for playing audio to a user;
an audio digitization circuit that is resident on the headset and operable for converting the user speech to data in a digital data format;
a raw data application resident in the headset for converting the user speech data in the digital data format to another voice data format;
a WPAN radio component that is resident on the headset and configured for converting the user speech data in the voice data format into a protocol format;
a host device configured with a WPAN radio component for transceiving user speech data with the headset in the protocol format;
a long range wireless network component that is resident on the host device for coupling with at least one remote device through a long range wireless network, the host device operable for transceiving the user speech data with the remote device.

14. The speech-directed system of claim 13 wherein the WPAN radio component uses a UWB protocol format.

15. The speech-directed system of claim 13 wherein the long range wireless network includes at least one of a cellular network, a WLAN network or a WMAN network.

16. The speech-directed system of claim 13 wherein the raw data application converts the user speech in the digital data format to a voice data format that is selected from the group of a voice-over-IP (VoIP) data format and streaming audio data format.

17. A headset for use in a speech-directed system comprising:
a microphone for capturing user speech from a user;
a speaker for playing audio to a user;
a speech recognition component operable for converting the user speech to data in a data format;
a WPAN radio component configured for converting the user speech from the data format into a protocol format for transceiving data with a host device over a WPAN wireless link.

18. The headset of claim 17 wherein the WPAN radio component uses a UWB protocol format.

19. The headset of claim 17 further comprising processing circuitry running an application configured for receiving the user speech in the data format, the application using the user speech data for directing a user in the completion of a work task.

20. The headset of claim 17 further comprising processing circuitry running a wedge application, the wedge application operable to convert the user speech data into a second data format usable by the host device before transceiving data with a host device over a WPAN wireless link.

21. The headset of claim 17 wherein the host device is a bridge device configured with an application to convert the data from a WPAN radio protocol format into a format for use in a long range wireless network for transceiving the user speech data with the remote device.

22. The headset of claim 17 wherein the protocol format implements at least one protocol from the group of a wireless USB protocol, an IEEE 1394 protocol, a Bluetooth protocol, and a wireless TCP/IP protocol.
